(19) United States
(12) Patent Application Publication
(10) Pub. No.: US 2025/0103275 A1
(43) Pub. Date: Mar. 27, 2025

(54) MEDIA CONTENT AND PLAYBACK CONFIGURATION DISCOVERY BASED ON MEDIA FORMAT

(71) Applicant: Sonos, Inc., Goleta, CA (US)

(72) Inventors: Ryan Michael Bello, Sammamish, WA (US); Hilario Coimbra, Boston, MA (US)

(21) Appl. No.: 18/895,240

(22) Filed: Sep. 24, 2024

Related U.S. Application Data
(60) Provisional application No. 63/585,489, filed on Sep. 26, 2023.

(51) Int. Cl. G06F 3/16

(52) U.S. Cl. CPC G06F 3/165

(57) ABSTRACT

Techniques for discovering playback configurations and/or media content based on format of the are disclosed. One method involves determining an audio format of a media item available for playback by a media playback system and determining one or more characteristics of the media playback system. Based on the audio format of the media item and the one or more characteristics of the media playback system, at least one indication of a media playback system configuration that enables playback of the media item in the audio format is provided.

### FIELD OF THE DISCLOSURE

This application claims the benefit of priority to U.S. Patent Application No. 63/585,489, filed Sep. 26, 2023, which is incorporated herein by reference in its entirety.

### FIELD OF THE DISCLOSURE

The present disclosure is related to consumer goods and, more particularly, to methods, systems, products, features, services, and other elements directed to media playback or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A is a partial cutaway view of an environment having a media playback system configured in accordance with aspects of the disclosed technology.

FIG. 1B is a schematic diagram of the media playback system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partial schematic diagram of a control device.

FIGS. 1-I through 1L are schematic diagrams of corresponding media playback system zones.

FIG. 1M is a schematic diagram of media playback system areas.

FIG. 2A is a schematic block diagram illustrating a process, flow or method of providing indications of playback configurations and/or media content available for a media playback system, in accordance with examples described herein.

FIG. 2B illustrates an example user interface, in accordance with examples described herein.

FIG. 3 is a schematic block diagram illustrating a process, flow or method that can be performed when a content is requested for playback, in accordance with examples described herein.

FIG. 4 is a schematic block diagram illustrating a process, flow or method that can be performed when content is requested for playback, in accordance with examples described herein.

FIG. 5 is a schematic block diagram illustrating a process, flow or method of collecting format data, in accordance with examples described herein.

FIG. 6 is a schematic block diagram illustrating a process, flow or method of filtering search results or other data by format, in accordance with examples described herein.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Some media playback systems include mono or stereo playback devices and playback devices capable of playing back content in more sophisticated formats, such as spatial audio formats. Users of such media playback systems may be interested in finding content that showcases and leverages the capabilities of their systems. For example, a user who owns a spatial audio-capable playback device (e.g., a SONOS ERA 300) may wish to find spatial audio content. However, discovering media content available in a particular format supported by the media playback system can be challenging.

For relatively newer and/or less conventional formats such as spatial audio formats, discovering media content can be a source of frustration, particularly spatial audio content without corresponding video. The amount of content available in these formats can be limited, and the ability to search/find such content is rudimentary or basically non-existing for most media content providers. Under many conventional approaches, for instance, there is no indication that a particular song is available in a spatial audio format unless the song happens to be listed in a correspondingly named playlist (e.g., with “Spatial Audio” in the name), or has some indication in a cover or landing page of the content (e.g., album art).

Some streaming media services may have a dedicated section listing content in a particular format. Even so, the dedicated sections typically lack the ability to search for specific content by format, and/or to filter search results by format. In many cases, there are not even format indications in the search results. Additionally, most media services are not capable of considering media playback system characteristics to recommend content and/or configurations that leverage the system's capabilities. The ability to search content by a desired format and/or based on the system's capability is therefore very limited.

Even when content is available in a particular spatial audio format, it may end up instead being played back in mono or stereo, or perhaps not played back at all for various reasons. In some instances, there may be playback configurations that enable or prevent playback in the particular format based on, for example, media playback system characteristics, media content provider characteristics, communications interface, channel or protocol, networking configurations, etc. For example, even if content is indicated as available in spatial audio format, a track sent via a communication protocol that does not support spatial audio (e.g., Airplay or Bluetooth) to a spatial audio-capable device may not play back in spatial audio. As another example, a spatial audio-capable device may not playback in spatial audio if grouped with less capable devices. As another example, a Dolby Atmos-capable home theater system may not be able to playback TV content in Dolby Atmos if the TV does not support pass-through of Dolby Atmos audio (or if the content provider does not support Dolby Atmos). As another example, bandwidth conditions could impact streaming and/or playback of higher resolution formats.

Some users may struggle to configure and/or troubleshoot their system in a way that enables playback in a particular format. For example, users may be unaware that a playback configuration enables or prevents playback in the particular format. Some users may be even unaware of the capabilities of their media playback system to play back content in the particular format. In some instances, even if the users own a spatial audio-capable playback device and are aware of the capabilities of their system they still may be unable to configure the system in a way that allows for spatial audio playback. In some scenarios, for example, users may be grouping the spatial audio-capable device with a non-spatial audio-capable device. In these cases, even if the user selects spatial audio content for playback, content may not be played back in spatial audio format.

Therefore, there is a need for techniques that allow the user to take full advantage of the capabilities of their systems, by helping the user find the content they want in the desired format that their system is capable of playing back, and/or by educating the users about the capabilities of their system and the playback configurations that prevent and/or enable playback in the desired format.

Some example techniques described in this disclosure involve determining media content available for playback in a particular format and/or playback configurations of a media playback system that enable (or perhaps prevent) playback in the particular format. For example, some techniques described herein involve determining that particular content is available for playback in spatial audio via a first playback configuration (e.g., a first playback device, a first combination of playback devices, a first streaming service, a first communication protocol, etc.) but not via a second/different playback configuration.

Some example techniques described in this disclosure additionally or alternatively involve providing indications of playback configurations in the media playback system that prevent/enable playback in the particular format. Some example techniques additionally or alternatively involve providing indications of media content available in the particular format when it is determined that the media playback system is capable of playing back in the particular format.

For example, for a media playback system comprising a first playback device that supports spatial audio and a second playback device that does not support spatial audio, some techniques described herein involve determining that spatial audio content is available for playback by the media playback system (e.g., that the media playback system is registered with a streaming service that provides/supports spatial audio content). Some techniques described herein additionally or alternatively involve determining that the media playback system supports spatial audio playback at least via the first playback device and/or does not support spatial audio playback at least via the second playback device.

In the scenario above and in accordance with some techniques described herein, the media playback system notifies a user that content is available in spatial audio and can be played back via their first playback device. Similarly, the user can be notified that spatial audio content is available but cannot be played back via the second playback device. Based on the particular playback configuration (e.g., if the first and second playback devices are grouped in a synchrony group), the media playback system can provide other indications (e.g., guidance to re-configure) to the user. In some examples, for instance, the media playback system notifies the user that if certain devices were ungrouped, spatial audio can be played back via the first playback device.

Multiple variations and/or combinations of these example techniques will be described in more detail below and/or can be derived from the example techniques described below.

In some examples, a method comprises determining an audio format of a media item available for playback via a media playback system; determining one or more characteristics of the media playback system; and based on the audio format of the media item and the one or more characteristics of the media playback system, provide at least one indication of a media playback system configuration that enables playback of the media item in the audio format.

In some examples, a computing system comprises at least one processor and at least one non-transitory computer-readable medium collectively comprising program instructions that are collectively executable via the at least one processor such that the computing system is configured to: provide, via a user interface associated with a media playback system, a first indication that a media item is available in a first audio format; receive, via the user interface, a request to play back, via one or more playback devices of the media playback system, the media item in the first audio format; determine a current playback configuration of the one or more media playback devices, wherein the current playback configuration prevents playback of the first audio format; based on the request and on the current playback configuration, provide, via the user interface, a second indication that the current playback configuration prevents playback of the first audio format; and cause the one or more playback devices to play back a rendition of the media item, wherein the rendition of the media item is in a second audio format different from the first audio format.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

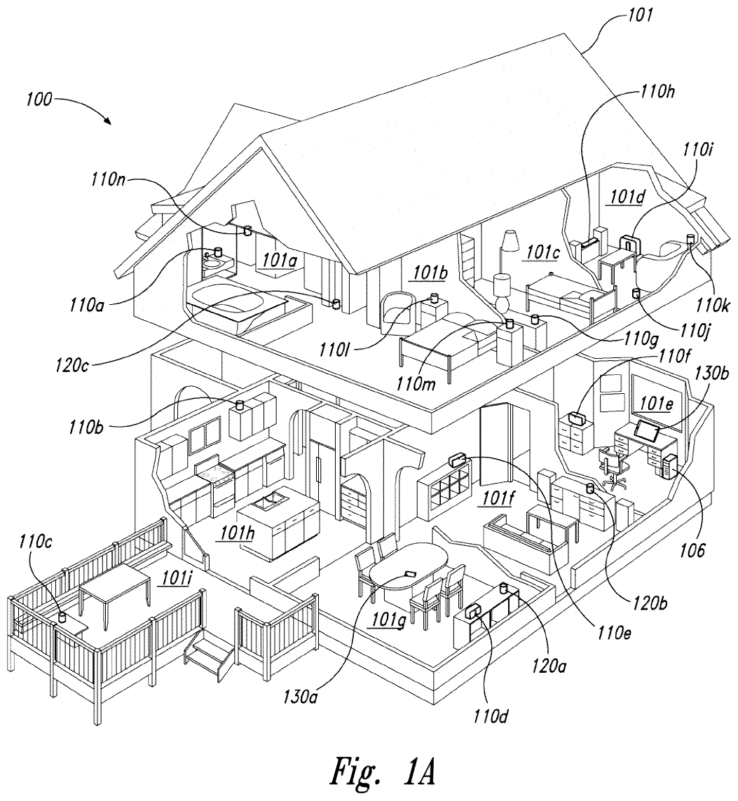

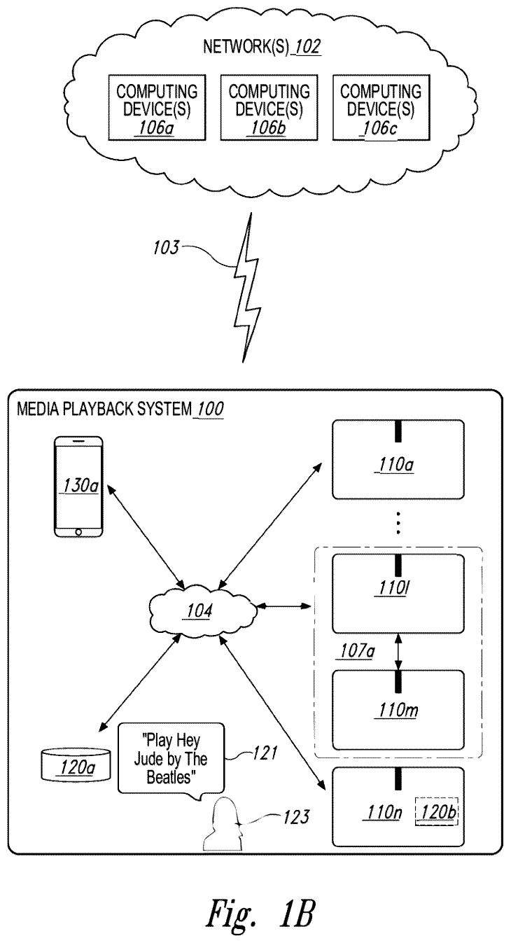

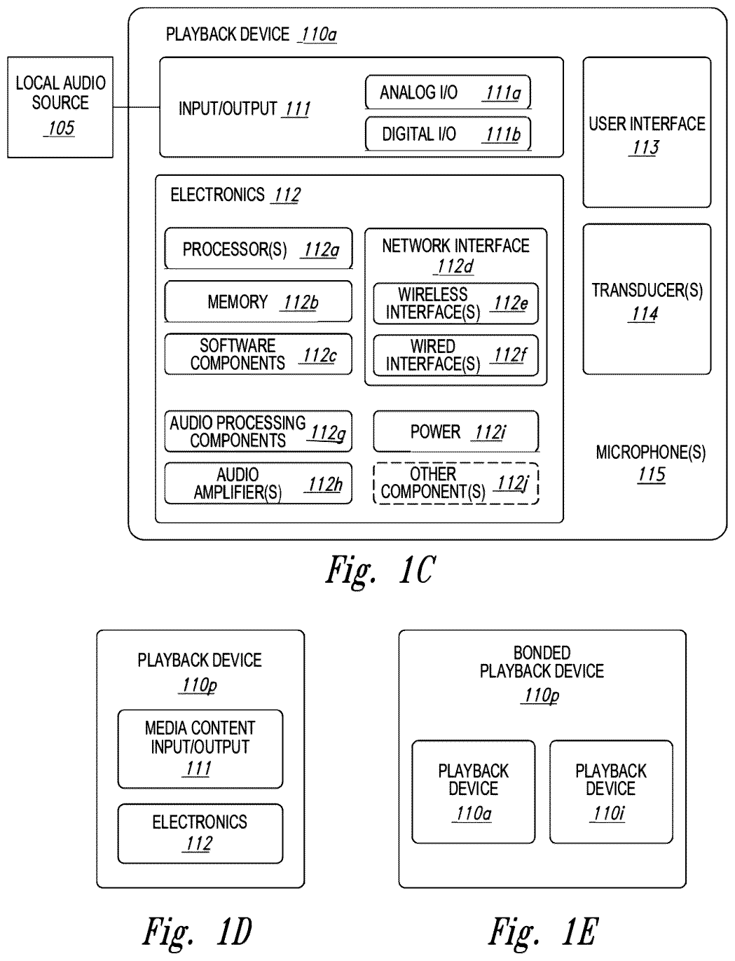

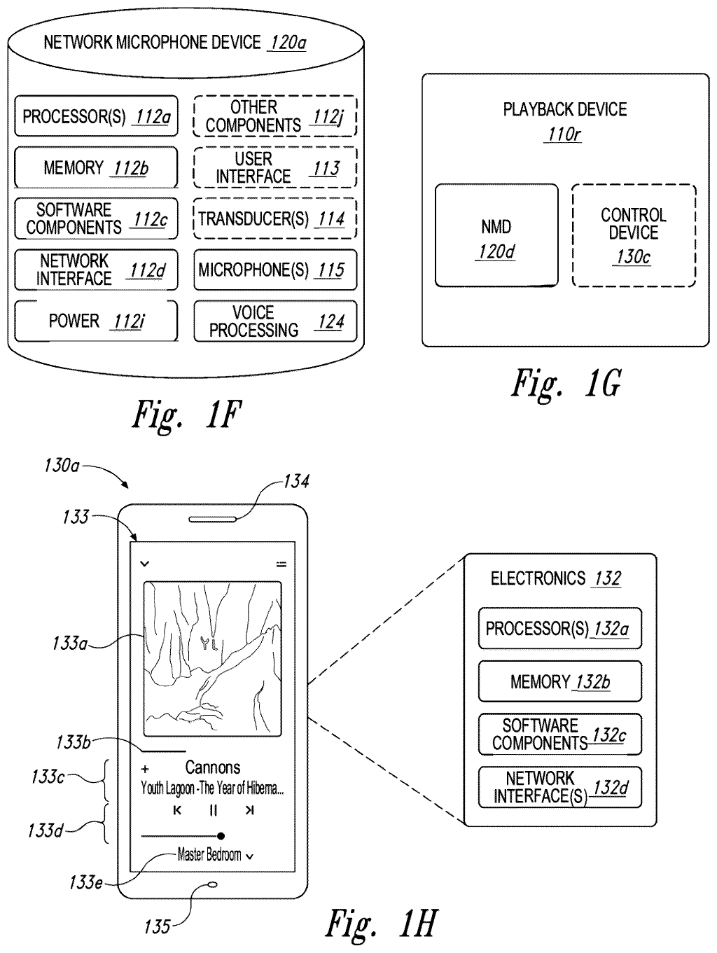

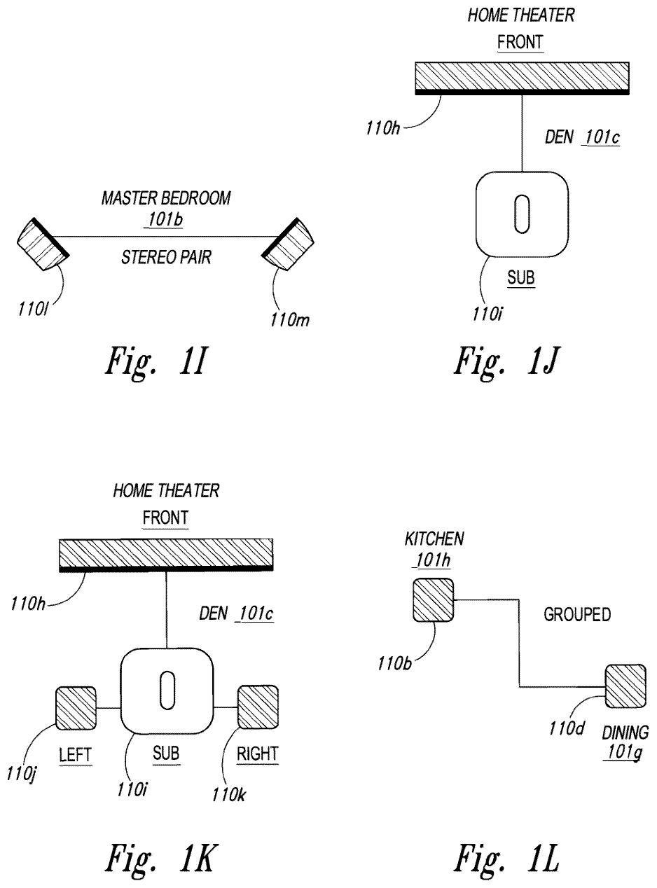

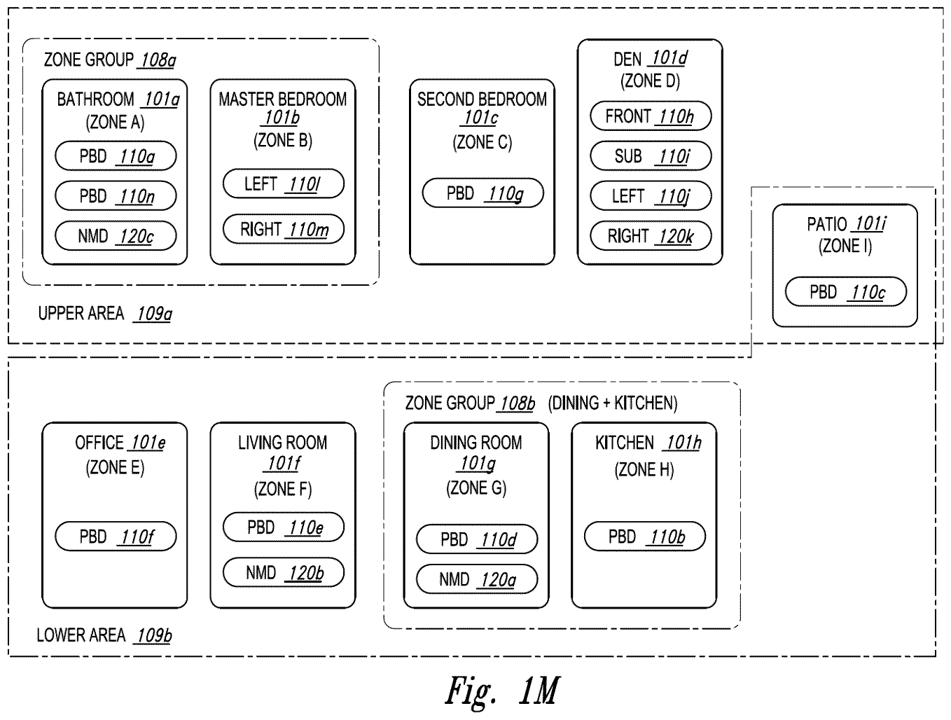

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., a house). The media playback system 100 comprises one or more playback devices 110 (identified individually as playback devices 110a-n), one or more network microphone devices 120 (“NMDs”) (identified individually as NMDs 120a-c), and one or more control devices 130 (identified individually as control devices 130a and 130b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term “NMD” (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., presence of a user in a kitchen, detection of a coffee machine operation). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below with respect to FIGS. 1B-1M.

In the illustrated embodiment of FIG. 1A, the environment 101 comprises a household having several rooms, spaces, and/or playback zones, including (clockwise from upper left) a master bathroom 101a, a master bedroom 101b, a second bedroom 101c, a family room or den 101d, an office 101e, a living room 101f, a dining room 101g, a kitchen 101h, and an outdoor patio 101i. While certain embodiments and examples are described below in the context of a home environment, the technologies described herein may be implemented in other types of environments. In some embodiments, for example, the media playback system 100 can be implemented in one or more commercial settings (e.g., a restaurant, mall, airport, hotel, a retail or other store), one or more vehicles (e.g., a sports utility vehicle, bus, car, a ship, a boat, an airplane), multiple environments (e.g., a combination of home and vehicle environments), and/or another suitable environment where multi-zone audio may be desirable.

The media playback system 100 can comprise one or more playback zones, some of which may correspond to the rooms in the environment 101. The media playback system 100 can be established with one or more playback zones, after which additional zones may be added, or removed, to form, for example, the configuration shown in FIG. 1A. Each zone may be given a name according to a different room or space such as the office 101e, master bathroom 101a, master bedroom 101b, the second bedroom 101c, kitchen 101h, dining room 101g, living room 101f, and/or the balcony 101i. In some aspects, a single playback zone may include multiple rooms or spaces. In certain aspects, a single room or space may include multiple playback zones.

In the illustrated embodiment of FIG. 1A, the master bathroom 101a, the second bedroom 101c, the office 101e, the living room 101f, the dining room 101g, the kitchen 101h, and the outdoor patio 101i each include one playback device 110, and the master bedroom 101b and the den 101d include a plurality of playback devices 110. In the master bedroom 101b, the playback devices 110l and 110m may be configured, for example, to play back audio content in synchrony as individual ones of playback devices 110, as a bonded playback zone, as a consolidated playback device, and/or any combination thereof. Similarly, in the den 101d, the playback devices 110h-j can be configured, for instance, to play back audio content in synchrony as individual ones of playback devices 110, as one or more bonded playback devices, and/or as one or more consolidated playback devices. Additional details regarding bonded and consolidated playback devices are described below with respect to FIGS. 1B and 1E and 1I-1M.

In some aspects, one or more of the playback zones in the environment 101 may each be playing different audio content. For instance, a user may be grilling on the patio 101i and listening to hip hop music being played by the playback device 110c while another user is preparing food in the kitchen 101h and listening to classical music played by the playback device 110b. In another example, a playback zone may play the same audio content in synchrony with another playback zone. For instance, the user may be in the office 101e listening to the playback device 110f playing back the same hip hop music being played back by playback device 110c on the patio 101i. In some aspects, the playback devices 110c and 110f play back the hip hop music in synchrony such that the user perceives that the audio content is being played seamlessly (or at least substantially seamlessly) while moving between different playback zones. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN), one or more local area networks (LAN), one or more personal area networks (PAN), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHZ, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing household communication network (e.g., a household WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct connections, PANs, telecommunication networks, and/or other suitable communication links. The network 104 may be referred to herein as a “local communication network” to differentiate the network 104 from the cloud network 102 that couples the media playback system 100 to remote devices, such as cloud services.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110l and 110m comprise a group 107a. The playback devices 110l and 110m can be positioned in different rooms in a household and be grouped together in the group 107a on a temporary or permanent basis based on user input received at the control device 130a and/or another control device 130 in the media playback system 100. When arranged in the group 107a, the playback devices 110l and 110m can be configured to play back the same or similar audio content in synchrony from one or more audio content sources. In certain embodiments, for example, the group 107a comprises a bonded zone in which the playback devices 110l and 110m comprise left audio and right audio channels, respectively, of multi-channel audio content, thereby producing or enhancing a stereo effect of the audio content. In some embodiments, the group 107a includes additional playback devices 110. In other embodiments, however, the media playback system 100 omits the group 107a and/or other grouped arrangements of the playback devices 110. Additional details regarding groups and other arrangements of playback devices are described in further detail below with respect to FIGS. 1-I through IM.

The media playback system 100 includes the NMDs 120a and 120d, each comprising one or more microphones configured to receive voice utterances from a user. In the illustrated embodiment of FIG. 1B, the NMD 120a is a standalone device and the NMD 120d is integrated into the playback device 110n. The NMD 120a, for example, is configured to receive voice input 121 from a user 123. In some embodiments, the NMD 120a transmits data associated with the received voice input 121 to a voice assistant service (VAS) configured to (i) process the received voice input data and (ii) facilitate one or more operations on behalf of the media playback system 100.

In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103.

In response to receiving the voice input data, the computing device 106c processes the voice input data (i.e., “Play Hey Jude by The Beatles”), and determines that the processed voice input includes a command to play a song (e.g., “Hey Jude”). In some embodiments, after processing the voice input, the computing device 106c accordingly transmits commands to the media playback system 100 to play back “Hey Jude” by the Beatles from a suitable media service (e.g., via one or more of the computing devices 106) on one or more of the playback devices 110. In other embodiments, the computing device 106c may be configured to interface with media services on behalf of the media playback system 100. In such embodiments, after processing the voice input, instead of the computing device 106c transmitting commands to the media playback system 100 causing the media playback system 100 to retrieve the requested media from a suitable media service, the computing device 106c itself causes a suitable media service to provide the requested media to the media playback system 100 in accordance with the user's voice utterance.

b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises an High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, a user interface 113 (e.g., one or more buttons, knobs, dials, touch-sensitive surfaces, displays, touchscreens), and one or more transducers 114 (referred to hereinafter as “the transducers 114”). The electronics 112 are configured to receive audio from an audio source (e.g., the local audio source 105) via the input/output 111 or one or more of the computing devices 106a-c via the network 104 (FIG. 1B)), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio data from an audio source (e.g., one or more of the computing devices 106a-c (FIG. 1B)), and/or another one of the playback devices 110. In some embodiments, the operations further include causing the playback device 110a to send audio data to another one of the playback devices 110a and/or another device (e.g., one of the NMDs 120). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, a digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

By way of illustration, SONOS, Inc. presently offers (or has offered) for sale certain playback devices including, for example, a “SONOS ONE,” “PLAY: 1,” “PLAY: 3,” “PLAY: 5,” “PLAYBAR,” “PLAYBASE,” “CONNECT: AMP,” “CONNECT,” and “SUB.” Other suitable playback devices may additionally or alternatively be used to implement the playback devices of example embodiments disclosed herein. Additionally, one of ordinary skilled in the art will appreciate that a playback device is not limited to the examples described herein or to SONOS product offerings. In some embodiments, for example, one or more playback devices 110 comprises wired or wireless headphones (e.g., over-the-ear headphones, on-ear headphones, in-ear earphones). In other embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110i (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 110l and 110m of FIG. 1B). In some embodiments, for example, the playback device 110a is full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, and the microphones 115. The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio components 112g (FIG. 1C), the amplifiers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD can be integrated into a playback device. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

d. Suitable Control Devices

FIG. 1H is a partial schematic diagram of the control device 130a (FIGS. 1A and 1B). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™, an Android phone) on which media playback system controller application software is installed. In some embodiments, the control device 130a comprises, for example, a tablet (e.g., an iPad™), a computer (e.g., a laptop computer, a desktop computer), and/or another suitable device (e.g., a television, an automobile audio head unit, an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 130 to one or more of the playback devices 100. The network interface 132d can also transmit and/or receive configuration changes such as, for example, adding/removing one or more playback devices 100 to/from a zone, adding/removing one or more zones to/from a zone group, forming a bonded or consolidated player, separating one or more playback devices from a bonded or consolidated player, among others. Additional description of zones and groups can be found below with respect to FIGS. 1-I through 1M.

The user interface 133 is configured to receive user input and can facilitate control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

e. Suitable Playback Device Configurations

FIGS. 11 through 1M show example configurations of playback devices in zones and zone groups. Referring first to FIG. 1M, in one example, a single playback device may belong to a zone. For example, the playback device 110g in the second bedroom 101c (FIG. 1A) may belong to Zone C. In some implementations described below, multiple playback devices may be “bonded” to form a “bonded pair” which together form a single zone. For example, the playback device 110l (e.g., a left playback device) can be bonded to the playback device 110m (e.g., a right playback device) to form Zone B. Bonded playback devices may have different playback responsibilities (e.g., channel responsibilities). In another implementation described below, multiple playback devices may be merged to form a single zone. For example, the playback device 110h (e.g., a front playback device) may be merged with the playback device 110i (e.g., a subwoofer), and the playback devices 110j and 110k (e.g., left and right surround speakers, respectively) to form a single Zone D. In another example, playback devices can be merged to form merged groups or a zone groups such as 108a and 108b. The merged playback devices may not be specifically assigned different playback responsibilities. That is, the merged playback devices may, aside from playing audio content in synchrony, each play audio content as they would if they were not merged.

Each zone in the media playback system 100 may be provided for control as a single user interface (UI) entity. For example, Zone A may be provided as a single entity named Bathroom. Zone B may be provided as a single entity named Master Bedroom. Zone C may be provided as a single entity named Second Bedroom.

Playback devices that are bonded may have different playback responsibilities, such as responsibilities for certain audio channels. For example, as shown in FIG. 1I, the playback devices 110l and 110m may be bonded so as to produce or enhance a stereo effect of audio content. In this example, the playback device 110l may be configured to play a left channel audio component, while the playback device 110m may be configured to play a right channel audio component. In some implementations, such stereo bonding may be referred to as “pairing.”

Additionally, bonded playback devices may have additional and/or different respective speaker drivers. As shown in FIG. 1J, the playback device 110h named Front may be bonded with the playback device 110i named SUB. The Front device 110h can be configured to render a range of mid to high frequencies and the SUB device 110i can be configured to render low frequencies. When unbonded, however, the Front device 110h can be configured to render a full range of frequencies. As another example, FIG. 1K shows the Front and SUB devices 110h and 110i further bonded with Left and Right playback devices 110j and 110k, respectively. In some implementations, the Right and Left devices 110j and 120k can be configured to form surround or “satellite” channels of a home theater system. The bonded playback devices 110h, 110i, 110j, and 120k may form a single Zone D (FIG. 1M).

Playback devices that are merged may not have assigned playback responsibilities, and may each render the full range of audio content the respective playback device is capable of. Nevertheless, merged devices may be represented as a single UI entity (i.e., a zone, as discussed above). For instance, the playback devices 110l and 110m in the master bedroom may have the single UI entity of Zone B. In one embodiment, the playback devices 110l and 110m may each output the full range of audio content each respective playback devices 110l and 110m are capable of, in synchrony.

In some embodiments, an NMD is bonded or merged with another device so as to form a zone. For example, the NMD 120b may be bonded with the playback device 110e, which together form Zone F, named Living Room. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. For example, referring to FIG. 1M, Zone A may be grouped with Zone B to form a zone group 108a that includes the two zones. Similarly, Zone G may be grouped with Zone H to form the zone group 108b. As another example, Zone A may be grouped with one or more other Zones C-I. The Zones A-I may be grouped and ungrouped in numerous ways. For example, three, four, five, or more (e.g., all) of the Zones A-I may be grouped. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

In various implementations, the zones in an environment may be the default name of a zone within the group or a combination of the names of the zones within a zone group. For example, Zone Group 108b can have been assigned a name such as “Dining+Kitchen”, as shown in FIG. 1M. In some embodiments, a zone group may be given a unique name selected by a user.

Certain data may be stored in a memory of a playback device (e.g., the memory 112c of FIG. 1C) as one or more state variables that are periodically updated and used to describe the state of a playback zone, the playback device(s), and/or a zone group associated therewith. The memory may also include the data associated with the state of the other devices of the media system, and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong. As a related example, identifiers associated with the second bedroom 101c may indicate that the playback device is the only playback device of the Zone C and not in a zone group. Identifiers associated with the Den may indicate that the Den is not grouped with other zones but includes bonded playback devices 110h-110k. Identifiers associated with the Dining Room may indicate that the Dining Room is part of the Dining+Kitchen zone group 108b and that devices 110b and 110d are grouped (FIG. 1L). Identifiers associated with the Kitchen may indicate the same or similar information by virtue of the Kitchen being part of the Dining+Kitchen zone group 108b. Other example zone variables and identifiers are described below.

In yet another example, the media playback system 100 may store variables or identifiers representing other associations of zones and zone groups, such as identifiers associated with Areas, as shown in FIG. 1M. An area may involve a cluster of zone groups and/or zones not within a zone group. For instance, FIG. 1M shows an Upper Area 109a including Zones A-D, and a Lower Area 109b including Zones E-I. In one aspect, an Area may be used to invoke a cluster of zone groups and/or zones that share one or more zones and/or zone groups of another cluster. In another aspect, this differs from a zone group, which does not share a zone with another zone group. Further examples of techniques for implementing Areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement Areas, in which case the system may not store variables associated with Areas.

### III. Media Content and Playback Configuration Discovery Based on Media Format

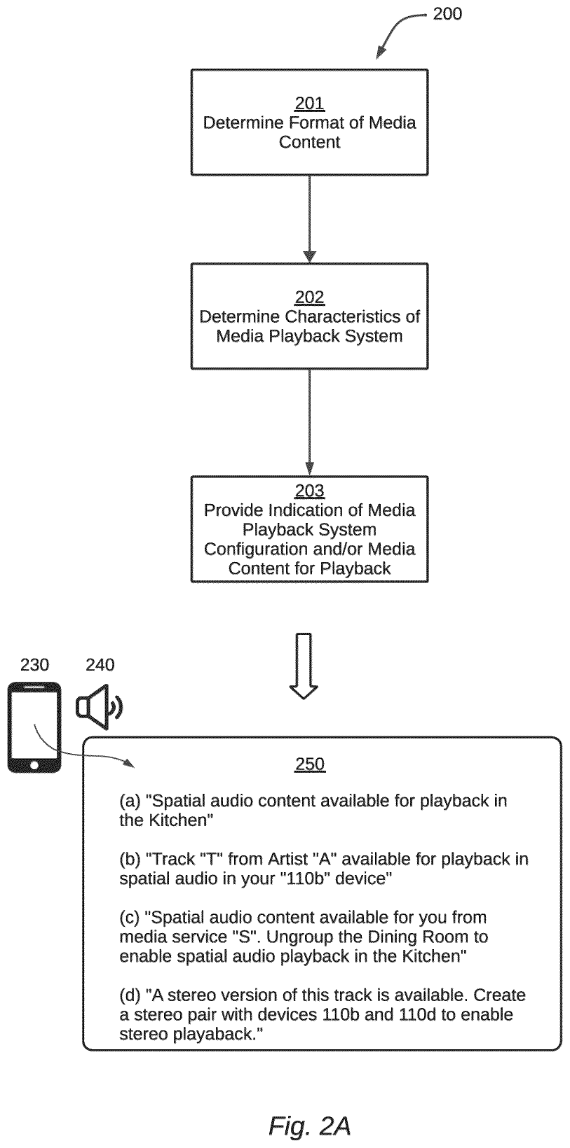

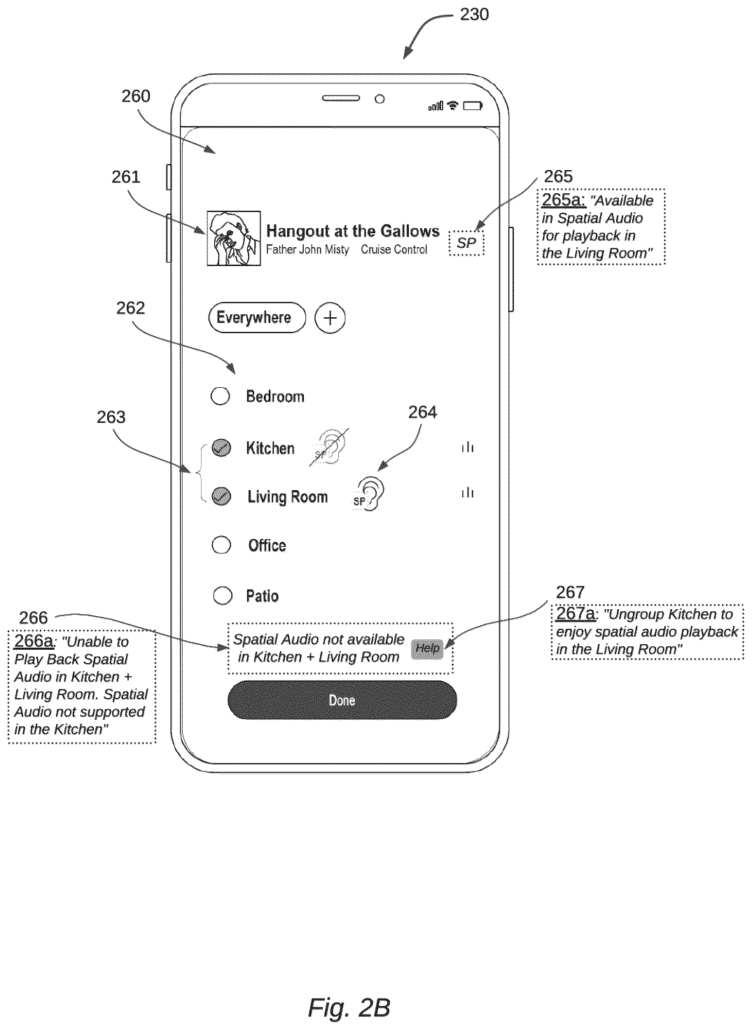

FIG. 2A is a schematic block diagram illustrating a process, flow or method 200 of providing indications of playback configurations and/or media content available for a media playback system. The indications can be based on the format of the media content and/or based on one or more characteristics of the media playback system. The different blocks in method 200 can be performed (individually or collectively) by one or more computing systems (e.g., one or more of the computing devices 106 in cloud network 102 of FIG. 1B). As described with reference to FIG. 1B, the one or more computing systems can be associated with one or more media services, such as streaming services, content providers and/or content management services, media playback system services, or the like. The computing system(s) can additionally or alternatively comprise any one or more other suitable computing devices such as other cloud computing systems, servers, user devices, control devices, playback devices, smart devices).

### a Determining Format of Media Content

At block 201, the method 200 comprises determining one or more formats of media content available for playback by a media playback system (e.g., media playback system 100 described with reference to FIGS. 1A-1M). The formats can comprise one or more audio formats such as a spatial audio format and/or another suitable media format such as a video format. As those of ordinary skill in the art will appreciate, spatial audio (and corresponding spatial audio formats) can generally refer to any multichannel audio scheme configured to simulate an immersive or three-dimensional (3D) listening experience. In some examples, the spatial audio comprises audio data encoded in one or more object-based spatial audio formats (e.g., Dolby Atmos. DTS: X). In some examples, the spatial audio can comprise another suitable surround sound format (e.g., ambisonics, Dolby Digital, DTS Digital Surround, Sony 360). In certain examples, spatial audio can comprise mono or stereo audio data that can be upmixed or otherwise filtered, processed, etc. to simulate a surround effect even if the audio data stream only includes one or two audio data channels, respectively. Regardless of the format, when rendered by a compatible media playback system, individual transducers and/or devices can output corresponding spatial audio and/or objects according to a particular playback responsibility that may be based on predicted, estimated or determined position(s) with respect to an expected listener location. Although many examples in this disclosure refer to spatial audio formats, the techniques described herein are broadly applicable to any media format.

The media content can be available at one or more media content sources. Media content sources can include any suitable one or more local and/or remote media source(s) such as any devices in the media playback system 100 (FIG. 1B) and/or user device(s) such as control device(s) 130 (FIG. 1H), one or more networked content source(s) such as streaming services, content management services, or any kind of remote content storage, any one or more of the computing devices 106 described with reference to FIG. 1B, etc.

In some instances, one or more media playback services can perform one or more of the blocks of method 200. The one or more media playback services can act as intermediary between the media playback system 100 and the content source(s). For example, the media playback service can comprise a media playback system service with which the media playback system is registered to manage multiple aspects of the media playback system. The media playback system can be registered with the media playback service via an account of the media service. In some instances, the media playback service comprises one or more of the content sources. For example, one or more of the content sources can be proprietary content stores and/or streaming services associated with the media playback service. In some instances, the media playback service acts as an intermediary and/or aggregator service to which multiple content sources (e.g., third party streaming services) can be associated. In any case, the different content sources can be associated with, and accessed via, the media playback service. Examples of how to register media services with a media playback system are described in U.S. Pat. No. 8,910,265, filed Sep. 28, 2012, entitled “Assisted Registration of Audio Sources”, which is incorporated herein by reference in its entirety.

In some examples, at block 201 the method 200 includes determining one or more content sources available to the media playback system (e.g., streaming services registered with the media playback system). The content sources available to the media playback system can be determined based on information stored locally by one or more devices of the media playback system and/or remotely by one or more computing systems (e.g., servers). For example, the playback devices can store information (e.g., software code, authorization credentials, a token, etc.) indicative of any streaming services that the media playback system has access to (e.g., is registered with). The content sources available to the media playback system can additionally or alternatively be determined based on information associated with a media playback system account of the media playback system. Content sources can also be determined based on other factors such as based on a detection of content sources connected to the media playback system via a suitable communication protocol/interface (e.g., a content source such as a user device physically connected via a line in audio interface, a content source connected via a protocol such as Bluetooth, WiFi, etc.)

In some examples, at block 201 the method 200 includes determining the media formats supported/provided by the content source(s) available to the media playback system. In some examples, at block 201 the method 200 includes determining if any content source associated with the media playback system supports/provides content in a particular format. Content sources can provide format information at any suitable time. For example, content sources can provide information about supported formats during a handshake procedure with the media playback system. As another example, content sources can provide format information whenever media content is accessed/provided for playback (e.g., as part of metadata associated with the content). In some instances, the media playback system and/or media service registered with the media playback system can “scan” and/or “parse” and/or “vet” the content from such content sources to make the format determination in block 201. This can include determining an encoding type used to encode the media content.

In some examples, at block 201 the method 200 includes determining a format of one or more particular media items available for playback via a media playback system. The one or more particular media items can comprise one or more of a media item requested for playback by the media playback system, a media item in a playback queue of the media playback system, a media item corresponding to (e.g., to be provided in response to) a search input, a media item to be provided/recommended for playback by the media playback system, etc. In some instances, the media playback system can have access to more than one content source, and the one or more media items can be from any one more content sources.

As described herein, the method 200 can involve determining a format of the media items in one or more ways. In some instances, the format can be determined based on metadata associated with the media items. For example, a media item can be stored in association with metadata indicating the format of the media item. In some instances, the metadata is obtained from the media content source rather than being included with the received media item data. In some examples, before determining the format in block 201, the method 200 optionally includes a separate block (not shown) of obtaining data corresponding to the media item from the media content source.

In some instances, format information corresponding to the media item can be determined by the media playback system and/or a media service registered with the media playback system by analyzing the media items (e.g., downloading and/or streaming and/or parsing and/or decoding the media item). In some instances, the format can be determined based on one or more characteristics of the media item(s). For example, one or more characteristics of the media item(s) such as encoding scheme, channel count, bitrate, sample rate, etc., can be analyzed to obtain format information.

In some instances, the method 200 comprises executing block 201 in response to and/or after a trigger. In some examples, the trigger comprises receiving an input via a user interface such as the user interface 133 (FIG. 1H). The input can include a selection or command to play back a media item. For example, the input can comprise a selection, via a graphical user interface, of a graphical representation corresponding to the media item. As another example, the input can comprise a voice command with a command to play back the media item. The input can comprise a search input associated with the media item such as an indication of the media item itself and/or some data indicative of the media item such as a title, a portion of the lyrics, an artist, etc. After receiving the input, the media playback system/service can proceed to determine the format of any media item corresponding to the input. This can include, for example, determining one or more content sources where the media item is available, the formats supported by such content sources, and/or the formats in which the media item is available in the one or more content sources.

In some instances, the input can be associated with a particular content source. For example, the user can search/select a media item for playback by a particular streaming service. In this case, block 201 can include determining the formats supported by the particular streaming service. Block 201 can also or alternatively include determining any formats in which the media item is available in the particular streaming service (e.g., different versions and/or renditions of a song in different formats such as stereo, spatial, lossless, etc.).

In some instances, the input can include a determination that new content is available at a particular content source. The format determination in block 201 can be triggered by the indication of the new content so that the format of the new content can be determined. In some instances, the input can include a determination that content that is potentially relevant to the user is available at a particular content source (e.g., based on a user playback profile profile and/or playback history). The format determination in block 201 can be triggered by the indication of the potentially relevant content so that the format can be determined. In this way, this potentially relevant content can be recommended to the user with a format indication.

b. Determining Characteristics of the Media Playback System

At block 202, the method 200 comprises determining one or more characteristics of a media playback system such as the media playback system 100 described with reference to FIGS. 1A-1M. The media playback system can comprise any number of playback devices. Some of the following examples reference playback devices 110b and 110d of FIGS. 1L and 1M, where playback devices 110b and 100d are associated with corresponding rooms 101h (Kitchen) and 101g (Dining). In other examples, the playback devices can be positioned elsewhere or in any other configuration such as in the same room or acoustic space.

In block 201, the method 200 comprises determining characteristics of any one or more of the playback devices in the media playback system 100. For example, the one or more characteristics can include a device identifier, a device MAC address, a device model, a device software version, etc., of one or more devices in the media playback system. The one or more characteristics can include characteristics related to a state/status of one or more devices in the media playback system such as whether the devices are on/off, online/offline, whether the devices are currently playing back content, whether there is content in a playback queue associated with the devices, whether any devices are grouped/bonded in a synchrony group, whether the devices are connected to a power source, a battery level, etc. The one or more characteristics can include characteristics related to a context associated with one or more devices in the media playback system such as the room with which the playback devices are associated, the acoustic space in which the devices are located, etc.

In some examples, the one or more characteristics include characteristics related to the content sources associated with the media playback system and/or being used to obtain content. For example, the one or more characteristic can include indications of any content sources available to the media playback system, formats supported by the content sources, an indication of a particular content source currently selected for playback by a playback device, and/or the mechanism to be used to obtain the content from the content source (e.g., casting from a user device, streaming directly from the streaming service, etc.).

In some examples, the one or more characteristics include characteristics related to the network connectivity including the communication interface, communication channel and/or protocol being used to communicate content to the media playback system, bandwidth availability, connection speed, etc.

The one or more characteristics can include characteristics related to the acoustic space in which the media playback system is deployed. For example, the one or more characteristics can include data indicating which devices are in the same acoustic space, whether the acoustic space is open or confined, whether there are users present in the acoustic space of the devices, etc. The one or more characteristics can include presence data related to the presence of users in a vicinity of one or more playback devices in the media playback system.

In some instances, the one or more characteristics can include characteristics related to the capabilities of the playback devices to play back a particular format. In this way, in some examples, block 202 optionally includes determining that one or more playback devices in the media playback system support the particular format (e.g., the format determined in block 201). For example, determining the one or more characteristics of the media playback system may comprise determining that 110b is a spatial audio-capable device. In some instances, determining the one or more characteristics of the media playback system comprises determining that one or more playback devices in the media playback system do not support the particular format. For example, determining the one or more characteristics of the media playback system can comprise determining that 110d is not capable of playing back spatial audio.

The determination of whether the playback devices support a particular format can be made directly from the one or more characteristics. For example, the one or more characteristics can include a list of formats supported by each payback device in the media playback system. In some instances, the determination of whether the media playback system supports the particular format can be instead derived from the one or more characteristics. For example, the one or more characteristics can include a device model, and the media playback service can determine whether the model supports the particular format based on other data such as a device data sheet or other data.

In instances in which two or more playback devices in the media playback system are grouped and/or bonded, the one or more characteristics of the media playback system can comprise respective characteristics of any group of playback devices in the system. For example, if 110b and 110d are grouped, determining the one or more characteristics can comprise determining that the devices are grouped, and/or that the group comprises at least one spatial audio capable device, and/or that the group comprises at least one device that does not support spatial audio, and/or that the group is not capable of playing back spatial audio (e.g., because it comprises at least one playback device that does not support spatial audio).

The one or more characteristics can be obtained directly by/from the media playback system. For example, one or more playback devices in the media playback system can share the status of the system (e.g., in a state variable) with other devices including remote devices and services, such as the media playback service. Alternatively or in combination, the one or more characteristics can be obtained by/from any other device (e.g., any other device in the household or environment in which the media playback system is deployed). For example, other smart devices in the household can share information (e.g., presence information, context information, or other information) with any other devices. Alternatively or in combination, the one or more characteristics can be received and/or determined by a first service (e.g., the media playback service) and shared with one or more other services. For example, the media playback service can determine the one or more characteristics and share them with a third-party service such as a streaming service for the purposes of obtaining media content recommendations particular to the given system. Examples of how to determine media playback system characteristics (e.g., related to system's capabilities) are described in Appendix A (U.S. Pat. App. No. 63/492,477, filed Mar. 27, 2023, entitled “Adaptive Streaming Content Selection for Playback Groups”), which is incorporated herein by reference in its entirety.

Blocks 201 and 202 can be performed at any time (e.g., before, after, or concurrently with one another). For example, in some instances, block 202 of determining the one or more characteristics of the media playback system can occur before block 201 so as to identify media content (via block 201) targeted to the specific characteristics of the media playback system. In some instances, any of the blocks in method 200 can be performed continuously (e.g., at regular intervals) so that the outcome is up to date.

c. Provide Indication of Playback Configuration and/or Media Content

At block 203, the method 200 comprises providing at least one indication of a media playback system configuration that corresponds to playback of the media content in a particular format. In many examples, the at least one indication is based on the audio format of the media content determined in block 201 and/or the one or more characteristics of the media playback system determined in block 202.

The playback configurations can be derived from the one or more characteristics. As mentioned before, the playback configurations can include any one or more playback devices, one or more content sources, one or more communication interfaces, channels and/or protocols, one or more networking configurations, and/or any other configuration related to playback of the media content by the media playback system. In some instances, multiple playback configurations are possible in a media playback system. In some instances, the playback configurations can include playback device configurations such as any of the example playback device configurations described with reference to FIG. 1M.

Based on the one or more characteristics determined in block 202, the media playback service can determine one or more playback configurations that enable playback in a particular format. For example, a first playback configuration comprising a first combination of playback devices, receiving content from a first content source, via a first protocol may be capable of supporting spatial audio playback. As another example, a second playback configuration comprising the same first combination of playback devices, receiving content from the same first content source, but via a second/different protocol may not support spatial audio playback. As another example, a third playback configuration comprising a third combination of playback devices can be capable of supporting spatial audio playback regardless of the content source or protocol being used. Other examples are possible.

In some examples, block 203 comprises providing an indication of media content in a particular format based on the characteristics of the media playback system. For example, if it is determined in block 201 that spatial audio content is available for playback, and it is determined in block 202 that the media playback system supports spatial audio playback, then block 203 can include providing an indication of the spatial audio content available for playback. Additionally or alternatively, block 203 can include providing an indication of media content in addition to an indication of a playback configuration that would enable playback of the media content. For example, block 203 can include indications of a first content (e.g., a first rendition of a media item in a first format) for a first playback device in the media playback system and indications of a second content (e.g., a second rendition of the media item in a second format) for a second playback device in the media playback system.

In some examples, the media playback system comprises at least one first playback device (e.g., 110b in the kitchen) that supports the media format (e.g., spatial audio). In some instances, the indication(s) provided in block 203 comprises an indication of a media playback system configuration that includes the at least one first playback device. Indications 250 (a) and (b) comprise examples of this type of indication.

In some examples, the media playback system comprises at least one second playback device (e.g., 110d in the dining room) that lacks capability to support the audio format. In some instances, the indication(s) comprise an indication of a media playback system configuration that excludes the additional playback device from the media playback system configuration. Indication 250 (c) comprises an example of this type of indication.

In some instances, the media playback system comprises at least one synchrony group comprising at least one playback device that supports the particular format (e.g., 110b), and at least one playback device that lacks capability to support the particular format (e.g., 110d). In those instances, the indication can comprise an indication to exclude the at least one second playback device from the synchrony group. Indication 250 (c) comprises an example of this type of indication.

In some instances, the media playback system can comprise two or more playback devices that, when grouped, can support the particular format. For example, 110b and 110d, if grouped, can be capable of playing back stereo content. The indication in block 203 can include an indication to group the devices for playback of stereo content. Indication 250 (d) comprises an example of this type of indication. Many other examples are possible.

The indications provided in block 203 of method 200 can be provided via a user interface associated with the media playback system. The user interface can comprise a graphical user interface displayed via a device (e.g., a controller of the media playback system such as control devices 130 described before in this disclosure, or a playback device comprising/associated with a display such as a TV, etc.). The graphical user interface can additionally or alternatively comprise a voice user interface of any playback device in the media playback system. The graphical user interface can additionally or alternatively comprise a hardware user interface of any playback device and/control/user device. The indications can comprise prompts (visual and/or auditory), messages, icons, images, videos, etc. The indications can be provided via a software application and/or web portal, or via push notifications, instant messages, text messages, email, or other means.

FIG. 2B illustrates an example user interface 260 that can be displayed via a user device, mobile device, a display device (e.g., a television, monitor, or projector), or a controller 230 of the media playback system. The user interface 260 illustrates an indication 261 of a media item available for playback by the media playback system. The media item can be a media item currently being played back by one or more devices of the media playback system, or a media item queued for playback, or a media item recommended for playback, or a media item provided based on a search input, etc.

User interface 260 also illustrates a list of room names 262 of the media playback system. Each room name can be associated with one or more playback devices. As illustrated in the example of FIG. 2B, the Kitchen and the Living Room are currently selected for playback back. In some instances, the Kitchen and the Living Room can form a synchrony group 263.

In some instances, format indications such as indication 264 of the formats supported/not supported by each room can be provided. The format indication 264 can be provided only for devices in the current playback configuration (the Kitchen and Living room currently selected for playback in this example) and/or for any other playback devices/rooms. In the illustrated example, the Kitchen does not support spatial audio while the Living Room does support spatial audio playback. In some instances, the format indication 264 can be provided based on the formats in which the media item (e.g., media item 261) is available. For example, if the media item is available in spatial audio (as determined in block 201 of method 200), an indication of the capability of each room/device to support spatial audio can be provided via the user interface.

In some instances, a format indication 265 can be provided in association with the media item. In the illustrated example, the format indication 265 indicates that the media item is available in spatial audio. The indication can be in the form of a dynamic badge that is updated based on the formats of the media content (e.g., as determined in block 201) and/or the characteristics of the media playback system (e.g., as determined in block 202). In some instances, the indication/badge can be provided for a media item that is currently being played back. In some instances, the indication/badge can be provided for a media item regardless of whether it is currently being played back (e.g., in a playback queue, in a list of search results, in a browsing page with content recommendations, etc.).

In some instances, a more detailed indication 265a can be provided (e.g., if the user interacts with/selects indication 265). In the illustrated example, the indication provides information that the media item is “available in spatial audio for playback in the Living Room”. This indication can be provided even if the media item is currently being played back in a format different than spatial audio so as to inform the user that the content is available in other formats and/or that their system is capable of playing it back.

Multiple different indications can be provided via the user interface. Indication 266 in user interface 260 illustrates an example indication where the user is notified that the current playback configuration (Kitchen+Living Room) does not support spatial audio. In some instances, the indication can further inform the user of the specific element in the playback configuration that is preventing spatial audio playback. Example indication 266a can inform the user that the system is “Unable to Play Back Spatial Audio in Kitchen+Living Room. Spatial Audio not supported in the Kitchen”. Indication 266a can be provided upon user interaction with any other format indication in the user interface. The user interface can include options (e.g., 267, 267a) to help the user understand/troubleshoot. Indication 267a in user interface 260 illustrates an example indication where the user is recommended an alternative playback configuration (ungrouping the Kitchen) that supports spatial audio playback. Multiple other examples are possible.

In some instances, a user may desire to experience content in a specific format. The media playback system may or may not be able to support the specific format (e.g., all playback devices in the media playback system may lack capability to playback the specific format). As explained before, in some instances, the media playback system may be able to support the specific format in a particular configuration (e.g., via a first playback device) but not in a second configuration (e.g., via a second playback device). In any instance, it would be beneficial to keep the user informed about the capabilities of their systems and playback configurations that may or may not enable playback in the desired format.

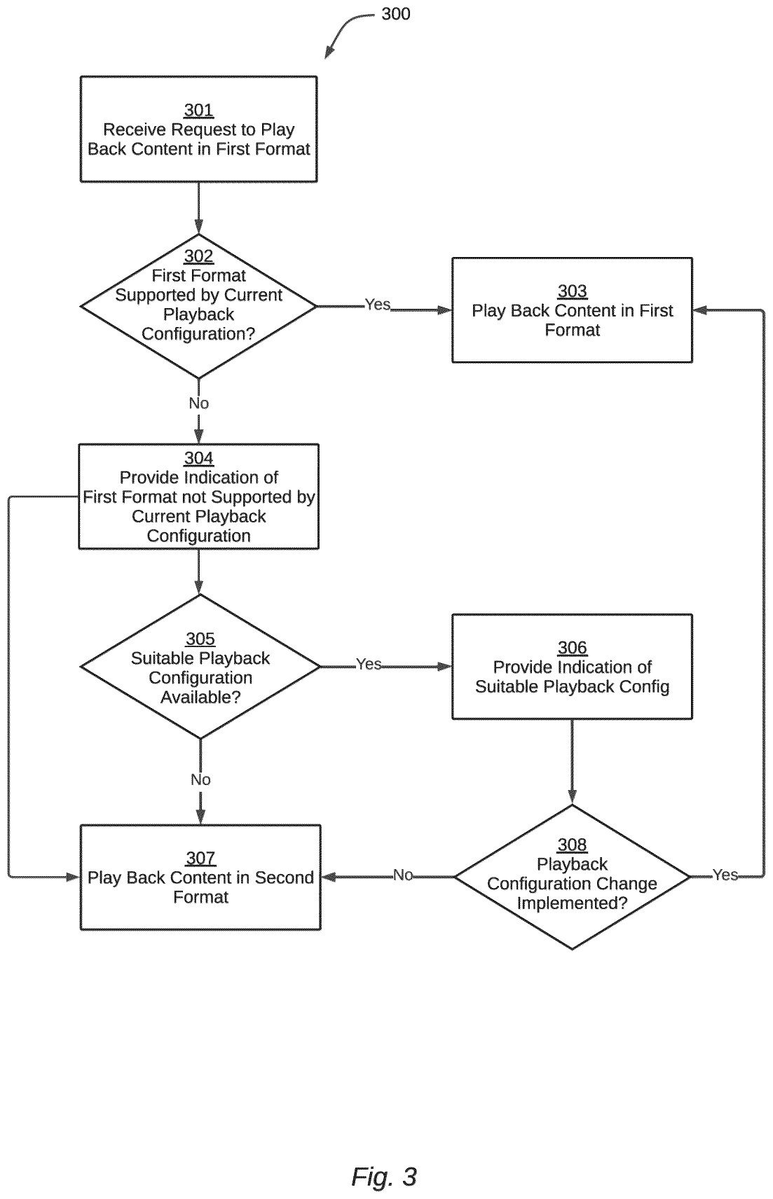

FIG. 3 is a schematic block diagram illustrating a process, flow or method 300 that can be performed when a request to playback content in a particular format is received (e.g., from a media playback system or a user of the media playback system). The different blocks in method 300 can be performed by any one or more of the computing system(s)/device(s) and/or media playback service(s) described with reference to method 200 in FIG. 2A.

At block 301, method 300 comprises receiving a request to play back, via one or more playback devices of the media playback system, a media item in a particular format. The request can be received via a user interface associated with the media playback system such as graphical user interface 260, or any other user interface. The request can be received, for example, via a selection of a graphical representation corresponding to the media item, such as representation 261 in FIG. 2B.

In some instances, the request in block 301 can be received after an indication that the media item is available in the particular format is provided. This indication can be provided via the user interface associated with the media playback system. For example, indication 265 in user interface 260 in FIG. 2B can be displayed to indicate that the media item 261 is available for playback in spatial audio. The user can select the indication to start playback of the media item in spatial audio format.

The indication of the media item available in the particular format can be provided without any user action. For example, it can be a recommendation passively provided to the user in a spatial audio browsing page. The indication can alternatively be provided upon a user action. For example, the indication can be provided after a user input corresponding to a search for the particular media item in the particular format. In any case, the request for playback in block 301 can be received via a user interface indicating that the user wishes to playback the particular media item in the corresponding format.

At block 302, method 300 comprises a decision block of determining whether the current playback configuration supports the format of the media item selected for playback. Block 301 can include conducting block 201 of method 200 of determining the format for the media item selected for playback. Block 302 can additionally or alternatively include determining a current playback configuration of the one or more media playback devices, for example by conducting block 202 of method 200 of determining one or more characteristics of the media playback system. The current playback configuration can be the playback configuration that the media playback system is in when the request is received. The current playback configuration can be a playback configuration currently selected/indicated for playback. For example, with reference back to FIG. 2B, the Kitchen+Living Room are selected for playback, but not the Bedroom. The current playback configuration would therefore include any Kitchen+Living Room playback device(s), but not the Bedroom.

If it is determined that the current playback configuration supports the format of the media content, method 300 can proceed to block 303 of playing back the media content in the desired format. In some instances, however, the current playback configuration may not support playback of the desired format. For example, the current playback configuration can include a playback device or communication protocol that does not support the desired format. In these cases, method 300 can proceed to block 304 of providing an indication that the current playback configuration prevents/does not support playback of the desired audio format. The indication can be provided via the user interface (e.g., indication 266 in FIG. 2B). In some instances, the indication can be provided based on the request received in block 301 and on the current playback configuration (e.g., determined in block 302). In other instances, the indication can be provided proactively to the user (e.g., an indication that the Kitchen does not support spatial audio playback can be provided next to a media item in a search result for content to be played back in the Kitchen).

At this point, method 300 can proceed to block 307 of playing back content in another format (i.e., in a format supported by the current playback configuration). This block can be optional and/or conducted in response to a user input to playback content in a different format. For example, in response to the indication provided in block 304, the user can then accept/select playback in another format. Block 300 can include the computing system causing the one or more playback devices to play back a second rendition of the media item that is in a second format different from the format desired in the first place.

In some instances, the desired format comprises a format that requires at least one hardware and/or software capability different from what is required for the second format. For example, the desired format and the second format can be related to different encoding types so that, if a playback device does not comprise a codec capable of decoding the content in one format, it is not capable of playing back the media content in that format. As another example, the desired format and the second format can be associated with a different number of individual audio channels. In some instances, the desired format comprises a spatial audio format and the second format comprises a non-spatial audio format. In some instances, the first audio format comprises a higher quality audio format and the second audio format comprises a lower quality audio format.

The current playback configuration may not support the desired format for various reasons. For example, the current playback configuration may include a playback device unable to support the desired format. As another example, the current playback configuration may include a playback device capable of supporting the desired format, but grouped or bonded in a synchrony group with a playback device that does not support it. As another example, the current playback configuration may include a communication channel or protocol unable to support the desired format, a streaming service unable to support the desired format, a networking condition that prevents playback of the desired format, etc.

In some examples, method 300 comprises a decision block 305 of determining whether an alternative playback configuration that enables playback in the desired format is available. Block 305 can include conducting block 202 of method 200 of determining characteristics of the media playback system to determine whether the media playback system would support the format in any configuration. If it is determined that there are no playback configurations available that would support the desired format, method 300 can proceed to block 307 of playing back content in the other, supported format. At this point, an indication can be provided via the user interface that there is no playback configuration available that would support the desired format.

In some instances when there is no playback configuration available that supports the desired format, users can be prompted with one or more options to guide the user build a system that would support the desired format. For example, the user can then be redirected to purchase products necessary for playback in the desired format. For example, the user can be redirected to buy a playback device capable of playing back spatial audio content, or to subscribe to a streaming service that provides spatial audio content, etc.

If, however, it is determined in block 305 that there is an alternative playback configuration that would support playback in the desired format, method 300 can proceed to block 306 of providing an indication of the alternative playback configuration. The indication that the current playback configuration prevents playback of the desired format (provided in block 304) and the indication of the alternative playback configuration (provided in block 306) can be the same or different indications. For example, a same prompt (e.g., prompts 266 and/or 267 in FIG. 2B) can indicate that spatial audio is not supported by the currently selected Kitchen+Living Room group, but would be supported by the Living Room alone.

At decision block 308, method 300 comprises determining whether a playback configuration change has been detected. This block can include detecting a change from the current/previous playback configuration (that does not support the desired format) to the alternative playback configuration (that would support the desired format). This block can be performed by continuously executing block 202 of method 200 of determining one or more characteristics (e.g., status) of the media playback system. As long as a change is not detected, method 300 can continue to block 307 of playing back content in the other, supported format. If, however, a playback configuration change is detected (e.g., to a playback configuration that supports the desired format), method 300 can proceed to block 303 of playing back content in the desired format. This can include causing the one or more playback devices to transition from playing back the current rendition of the media item to playing back another rendition of the media item which is in the desired format.

The alternative playback configuration can be a configuration that does support the desired format. For example, in a scenario in which the current playback device configuration comprises a playback device that lacks capability to play back content in the first audio format, the alternative playback configuration can exclude such playback device (e.g., exclude the Kitchen playback device(s) in the example of FIG. 2B). As another example, in a scenario in which the current playback device configuration comprises a second playback device capable of playing back content in the desired format, the alternative playback configuration can include the second playback device and exclude any that does not support the desired format (e.g., include the Living Room playback device(s) in the example of FIG. 2B).

As another example, in a scenario in which all the playback devices in the current playback configuration lack capability to play back content in the desired format, the alternative playback configuration can include at least one additional playback device of the media playback system able to play back content in the first audio format. For example, the current playback configuration can have included only the Kitchen, and the alternative playback configuration can include the Living Room instead.

As another example, there can be a scenario in which the media playback devices in the current playback configuration are capable of playing back content in the first audio format if grouped or bonded in a synchrony group with at least one additional playback device in the media playback system. In this case, the alternative playback configuration can include a synchrony group comprising the one or more media playback devices and the at least one additional playback device. For example, playback devices used as surrounds in a home theater system in the Living Room may not be capable of playing back spatial audio content on their own, but if grouped with another playback device (e.g., a soundbar), the group can be able to playback spatial audio. As another example, a playback device may not be able to playback multi-channel content on its own because it may lack the resources to play back all the channels (e.g., it may not include up-firing transducers). This playback device can be grouped with other playback devices that can provide the missing channels. For example, a playback device can be placed on top of another and configured to provide the upper channels that the bottom playback device may not be able to reproduce. Many other examples are possible.

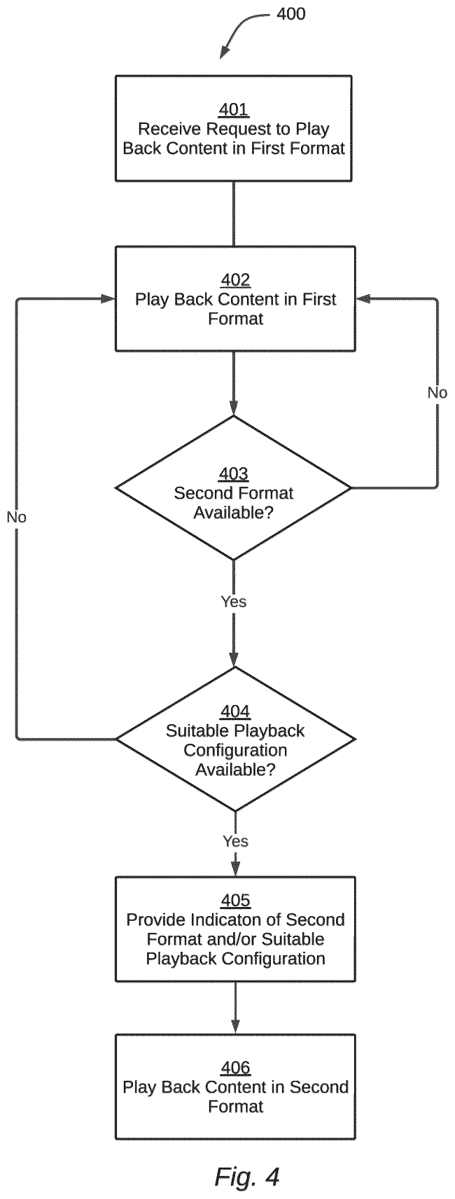

In some examples, the content requested for playback may be available in other formats supported by the media playback system in addition to the requested format. For example, the user may select a “non-spatial audio” version of a song to be played back by their spatial audio-capable media playback system. In these instances, the user may select the non-spatial audio version on purpose (e.g., maybe the user does not wish to listen to content in spatial audio). However, in some instances, the user may select the non-spatial audio version because the user is not aware that the content is available in spatial audio and/or because the user is not aware that their system is capable of playing back spatial audio. Maybe the user could not find the content in spatial audio, or could not configure their system to play back in spatial audio. FIG. 4 is a schematic block diagram illustrating a process, flow or method 400 that can be performed when content is requested for playback to address these kinds of situations. The different blocks in method 400 can be performed by the media playback service(s) and/or by any of the computing system(s)/device(s) described with reference to methods 200 and 300 in FIGS. 2A and 3, respectively.

At block 401, method 400 comprises receiving (e.g., via the user interface) a request to play back a media item in a first format via one or more playback devices of the media playback system. This block can be the same or similar to block 301 of method 300. The request can include a request to play back a first rendition of the media item which is in the first format. If the format is supported by the current playback configuration, method 400 can proceed to block 402 of playing back the content in the desired format. This block can be the same or similar to block 303 of method 300.

At decision block 403, method 400 comprises determining if a second rendition of the media item is also available for playback by the one or more playback devices in a second format different than the first format. This block can include conducting block 201 of method 200 of determining the format of media content available for playback. If the media item is not available in any other format, method 400 can continue to block 402 of playing back content in the first format.

If, however, the media item is available in a second format, method 400 can proceed to a decision block 404 of determining whether there is a playback configuration available that supports the second format. Block 404 can include determining a capability of the at least one playback device to play back content in the second format. This block can include conducting block 202 of method 200 of determining one or more characteristics of the media playback system. At this point (e.g., based on the request and on the capability of the one or more media playback devices), if there is no playback configuration available that would support the second format, method 400 can continue to block 402 of playing back the first format.

If there is, however, a playback configuration available that would support the second format, method 400 can proceed to block 405 of providing (e.g., via the user interface) an indication that a second rendition in a second format is available for playback and/or an indication of a playback configuration that enables playback of the second format. In some instances, the current playback configuration enables playback of the audio format, and therefore there would be no need of providing an indication of any alternative playback configuration at this point.

Method 400 can continue to play back content in the first format (block 402) even if the second format is available (e.g., because the first format was the format selected by the user). In some examples, a user input (e.g., accepting the second format) may be required to switch to the second format. In these instances, the media playback service can cause the one or more playback devices to play back the first rendition of the media item in the first audio format. In other instances, method 400 can continue to execute block 406 of playing back content in the second format. In some examples, block 406 is executed after a user input (e.g., accepting the second format) is received. In some instances, the media playback service can cause the one or more playback devices to play back the second rendition of the media item in the second audio format (and/or to switch from playing back the first rendition to playing back the second rendition).

d. Crowdsourcing Format Data

As described above, discovering content available in a particular format can be challenging. In some instances, content sources provide some kind of metadata indicative of the format of the content. In other instances, content sources do not provide any indication of the format of the media content. In some instances, an intermediary service (e.g., the media playback service) can be able to determine the format of the media item as the media item is streamed and/or played back by the media playback system. For example, media service 220 can fetch media content for playback by a media playback system from a media content source, and parse the media item to determine the format (e.g., by performing block 201 of method 200 in FIG. 2A). At this point, the format data can be stored in association with the media item in a format data store that can be used to find content in that format in other instances (e.g., by the same user or other users). In this way, format data can be crowdsourced from content played back by multiple media playback systems and used to build a format data store that can be used to provide format indications, to find and/or filter content by format, and so much more.

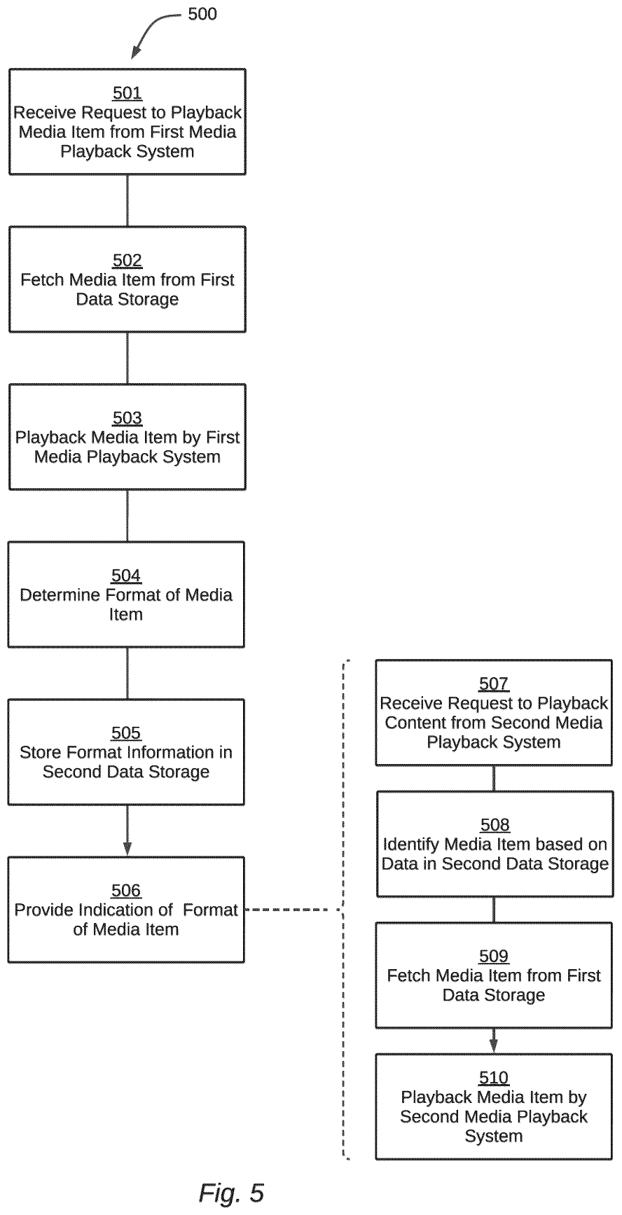

FIG. 5 is a schematic block diagram illustrating a process, flow or method 500 of collecting format data for media content played back by one or more media playback systems. The different blocks in method 500 can be performed by the media playback service(s), and/or by any of the computing system(s)/device(s) described with reference to methods 200, 300 and/or 400 in FIGS. 2, 3 and/or 4, respectively.

At block 501, method 500 comprises receiving, from a first media playback system, a first request to play back a media item. The request can comprise or otherwise be associated with a media item identifier. Method 500 includes a block 502 of fetching the media item from a content source. In some instances, the media item can be fetched using the media item identifier. In some instances, the media item identifier identifies a location (e.g., a media content source) where the media item is available. For example, the media item identifier can comprise a locator such as a URL of the media item.

At block 503, method 500 comprises causing the first media playback system to play back the media item. At block 504, method 500 comprises, determining a format of the media item. This can include performing block 201 of method 200. Block 504 can be conducted while the first media playback system is playing back the media item. At block 505, method 500 comprises storing an association of the audio format with the media item identifier. The association can be stored in a format data storage different from the content source from which the media item was obtained.

At block 506, method 500 comprises providing an indication of the format of the media item. The indication can be provided using the data stored in block 505. The indication can be provided to the same or a different media playback system. In some instances, block 506 can include one or more of blocks 507, 508, 509 and 510 of receiving, from a second media playback system different from the first media playback system, a request for media content in the particular format, determining that the media item is in the particular format based on the association stored in the format data storage, retrieving the media item from the content source using the media item identifier in the format data storage, and causing the second media playback system to play back the media item.

e. Filtering by Format

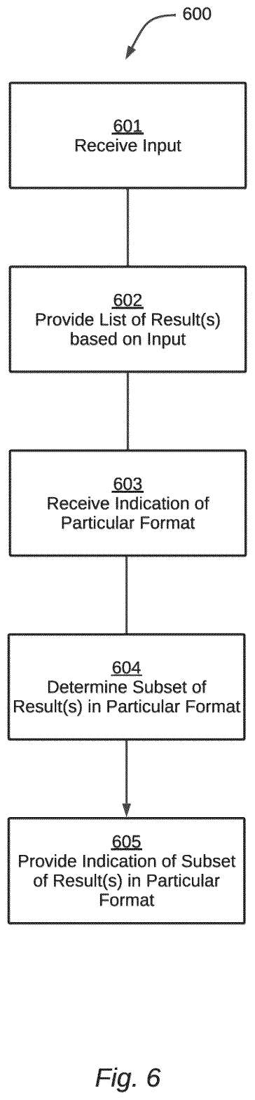

In some instances, users can filter search results or other data by format. For example, users can search content available in a particular format, streaming services that provide a particular format, playback devices in their media playback system that are capable of playing back a particular format, etc. FIG. 6 is a schematic block diagram illustrating a process, flow or method 600 of filtering search results or other data by format. The different blocks in method 600 can be performed by the media playback service(s) and/or by any of the computing system(s)/device(s) described with reference to methods 200, 300, 400 and/or 500 in FIGS. 2, 3, 4 and/or 5, respectively.

At block 601, method 600 comprises receiving an input. The input can be received via a user interface. The input can include a search criteria (e.g., an artist name, a track title, etc.), a selection of a particular tab/option in a user interface (e.g., a “rooms” tab, a “streaming services” tab), or any other input that causes the user interface to provide a list of options in response to the input. For example, Block 601 can include receiving an input indicating a search criteria for media content available for playback by a media playback system. At block 602, method 600 comprises providing a list of results based on the input. For example, block 602 can include, based on the input, providing a list of media items available for playback by the media playback system that match the search criteria.

At block 603, method 600 comprises receiving an indication of a particular format. This indication can be received via the user interface. For example, the user interface can include options to toggle on/off a filter for spatial audio content. In some instances, block 603 can include receiving an indication of a particular playback device (or devices) which is to play back the media content and determining an audio format supported by the playback device. The particular audio format would then be the audio format supported by the playback device.

At block 604, method 600 comprises determining a subset of results that match the particular format. For example, block 604 can include determining a subset of media items in the list of media items available for playback in the particular audio format. At block 605, method 600 comprises providing an indication of the subset of results (e.g., via the user interface). For example, block 605 can include providing an indication of the subset of media items in the list of media items.

Determining the subset of results can comprise filtering the results. The filtering can be conducted locally (e.g., by the device displaying the results) or remotely (e.g., by the media playback service). The filtering can be conducted based on format data associated with the results. For example, the filtering can be conducted using format data stored in a format data store in block 505 of FIG. 5. The filtering can be conducted based on data obtained by executing blocks 201 and/or 202 of method 200. For example, the filtering can be conducted based on format data determined from the media content, based on the capabilities of playback devices and/or streaming services to playback a particular format, etc.

One example use case for the method 600 can comprise filtering content by format. For example, block 601 can include receiving an input indicating a search criteria for media content available for playback by a media playback system. Block 602 can include, based on the input, providing a list of media items available for playback by the media playback system that match the search criteria. Block 603 can include receiving an indication of a particular format. Block 604 can include determining a subset of media items in the list of media items available for playback in the particular format. Block 605 can include providing an indication of the subset of media items in the list of media items.

Another example use case for the method 600 can comprise filtering playback devices and/or rooms in the media playback system based on format supported by those devices/rooms. For example, block 601 can include selecting a tab or option in a user interface to see playback devices and/or rooms available in a media playback system (such as user interface 260 in FIG. 2B). For example, a user interface in a control device can display a list of two or more groups of one or more playback devices of the media playback system. Block 602 can include receiving an indication of a particular format. Block 603 can include determining a subset of groups capable of playing back content in the particular format. The subset of groups can include any group that supports the particular format (e.g., the Living Room) and any groups (e.g., the Kitchen) that don't support the particular format. Block 605 can include displaying an indication of the subset of groups (e.g., e.g., displaying only the Living Room and excluding the Kitchen).

Another example use case for the method 600 can comprise filtering content sources (e.g., streaming services) based on the format supported/provided by those services. For example, block 601 can include the selection of a “content sources” option that causes the user interface to provide a list of content sources available to the media playback system (e.g., content sources already registered and/or available to register with the media playback system). Block 602 can include displaying a list of two or more media services. Block 603 can include receiving an indication of a particular format. Block 604 can include determining a subset of media services in the list capable of providing content in the particular format. The subset of media services can include any media service in the list of two or more media services that supports the particular format and exclude any media service that does not support the particular format. Block 605 can include displaying an indication of the subset of media services.

f. Other Considerations

In some instances, different playback devices can playback different “streams” or “renditions” of a same media item based on the format supported by the playback devices. For example, if a playback device capable of playing back spatial audio is grouped with a playback device that does not support spatial audio for synchronous playback, each device can be provided with a stream/rendition of a format supported by the devices and corresponding timing information so that both devices play back the content in synchrony.

For playback devices that are in the same acoustic space, this approach may not be the most effective because the acoustic effect produced by playback devices playing back different renditions in different formats may not be ideal. However, for playback devices in different acoustic spaces, this approach can provide the user with the opportunity to enjoy spatial audio in playback devices that support it while simultaneously playing a non-spatial rendition of the content by playback devices that do not support spatial audio. The determination of whether the devices are in the same acoustic space can be made based on presence information detected by the devices. Examples of how to disambiguate and/or determine an acoustic space(s) are described in Appendix B (U.S. Pat. App. No. 63/377,881, filed Sep. 30, 2022, entitled “Voice Disambiguation via Acoustic Space Determination”), which is incorporated herein by reference in its entirety.

Some playback devices (e.g., wearables such as headphones) can be capable of playing back content in different formats (e.g., spatial audio format). These devices can be “grouped” (for example two or more different headphones can be paired with a soundbar so that two or more users can watch a movie together). In these scenarios, if one or more of the headphones is capable of playing back spatial audio and one or more of the headphones is not, different streams/renditions can be sent to each headphone accordingly. In this case, the different renditions can be sent regardless of whether the devices are in the same acoustic space because the devices are intended for individual playback rather than for out-loud playback, and content played back by one device will likely not interfere with content played back by the other device.

In some instances, different streams can also be selectively sent to different playback devices based on other contextual data. For example, two or more (e.g., all) playback devices in a system can be grouped for playback (e.g., in a “play everywhere” or “party” mode). Those devices can support a particular format that can be more resource hungry than other formats. In some instances, all playback devices can playback the same rendition (e.g., so that they all play spatial audio). In other instances, based on contextual data and/or the one or more characteristics of the media playback system, at least some of the playback devices can play back another rendition in another format (e.g., a non-spatial audio format) even if they are capable of playing back the same format. The contextual data can be related to the presence of users in the acoustic space of the devices. For example, if it is determined that there are no users present in a particular acoustic space, a playback device in such acoustic space can play back a rendition in another format (e.g., with less channels, lower quality, etc.). In this way, resources such as bandwidth can be optimized. As another example, if it is determined that a playback device is no longer connected to a power source and is instead operating on battery, the format can be downgraded based on battery levels to optimize power consumption and extend playback.

### IV. Conclusion

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The disclosed technology is illustrated, for example, according to various examples described below. Various examples of examples of the disclosed technology are described as numbered examples (1, 2, 3, etc.) for convenience. These are provided as examples and do not limit the disclosed technology. It is noted that any of the dependent examples may be combined in any combination, and placed into a respective independent example. The other examples can be presented in a similar manner.

Example 1. A computing system comprising: at least one processor; at least one non-transitory computer-readable medium collectively comprising program instructions that are collectively executable via the at least one processor such that the computing system is configured to: provide, via a user interface associated with a media playback system, a first indication that a media item is available in a first audio format; receive, via the user interface, a request to play back, via one or more playback devices of the media playback system, the media item in the first audio format; determine a current playback configuration of the one or more media playback devices, wherein the current playback configuration prevents playback of the first audio format; based on the request and on the current playback configuration, provide, via the user interface, a second indication that the current playback configuration prevents playback of the first audio format; and cause the one or more playback devices to play back a rendition of the media item, wherein the rendition of the media item is in a second audio format different from the first audio format.

Example 2. The computing system of any one of the preceding Examples, wherein the first audio format comprises a spatial audio format and the second audio format comprises a non-spatial audio format.

Example 3. The computing system of any one of the preceding Examples, wherein the first audio format comprises a higher quality audio format and the second audio format comprises a lower quality audio format.

Example 4. The computing system of any one of the preceding Examples, wherein the first audio format comprises more individual audio channels than the second audio format.

Example 5. The computing system of any one of the preceding Examples, wherein the user interface comprises one or more of a graphical user interface of any one or more of a controller or a playback device of the media playback system; a hardware user interface of any one or more of a controller or a playback device of the media playback system; or a voice user interface of any one or more of a controller or a playback device of the media playback system.

Example 6. The computing system of any one of the preceding Examples, wherein the current playback configuration comprises one or more of: a first playback device unable to support the first audio format; a second playback device capable of supporting the first audio format, wherein the second playback device is in a synchrony group with the first playback device; a communication channel or protocol unable to support the first audio format; a streaming service unable to support the first audio format; or a networking condition that prevents playback of the first audio format.

Example 7. The computing system of any one of the preceding Examples, wherein the at least one non-transitory computer-readable medium further collectively comprises program instructions such that the computing system is configured to: determine an alternative playback configuration that enables playback in the first audio format; and provide, via the user interface, an indication of the alternative playback configuration.

Example 8. The computing system of any one of the preceding Examples, wherein the indication that the current playback configuration prevents playback of the first audio format and the indication of the alternative playback configuration are a same indication.

Example 9. The computing system of any one of the preceding Examples, wherein the at least one non-transitory computer-readable medium further collectively comprises program instructions such that the computing system is configured to: detect a change from the current playback configuration to the alternative playback configuration; and based on the change, cause the one or more playback devices to transition from playing back the second rendition of the media item to playing back the first rendition of the media item.

Example 10. The computing system of any one of the preceding Examples, wherein: the current playback device configuration comprises at least one first playback device that lacks capability to play back content in the first audio format; and the alternative playback configuration excludes the at least one first playback device.

Example 11. The computing system of any one of the preceding Examples, wherein: the current playback device configuration comprises at least one second playback device capable of playing back content in the first audio format; and the alternative playback configuration includes the at least one second playback device.

Example 12. The computing system of any one of the preceding Examples, wherein: the one or more media playback devices in the current playback configuration all lack capability to play back content in the first audio format; and the alternative playback configuration includes at least one additional playback device of the media playback system able to play back content in the first audio format.

Example 13. The computing system of any one of the preceding Examples, wherein: the one or more media playback devices in the current playback configuration are capable of playing back content in the first audio format if grouped or bonded in a synchrony group with at least one additional playback device in the media playback system; and the alternative playback configuration includes a synchrony group comprising the one or more media playback devices and the at least one additional playback device.

Example 14. A method comprising: determining an audio format of a media item available for playback via a media playback system; determining one or more characteristics of the media playback system; and based on the audio format of the media item and the one or more characteristics of the media playback system, provide at least one indication of a media playback system configuration that enables playback of the media item in the audio format.

Example 15. The method of any one of the preceding Examples, wherein determining the audio format comprises determining the audio format based on metadata associated with the media item.

Example 16. The method of any one of the preceding Examples, wherein determining the audio format comprises parsing one or more characteristics of the media item to obtain the audio format.

Example 17. The method of any one of the preceding Examples, further comprising, before determining the audio format of the media item, obtaining data corresponding to the media item from a media content source.

Example 18. The method of any one of the preceding Examples, wherein obtaining data corresponding to the media item from the media content source comprises streaming the media item from the media content source.

Example 19. The method of any one of the preceding Examples, further comprising, before determining the audio format of the media item, receiving an input corresponding to a search criteria associated with the media item.

Example 20. The method of any one of the preceding Examples, wherein determining the one or more characteristics of the media playback system comprises receiving the one or more characteristics from at least one device of the media playback system.

Example 21. The method of any one of the preceding Examples, wherein: the media playback system comprises at least one playback device; and the one or more characteristics of the media playback system comprise respective at least one characteristic of the at least one playback device.

Example 22. The method of any one of the preceding Examples, wherein the respective at least one characteristic comprises an indication of the at least one playback device's capability to play back content in the audio format.

Example 23. The method of any one of the preceding Examples, wherein: the media playback system comprises at least one group of two or more playback devices; and the one or more characteristics of the media playback system comprise respective at least one characteristic of the at least one group of two or more playback devices.

Example 24. The method of any one of the preceding Examples, wherein determining the one or more characteristics of the media playback system configuration comprises determining that a particular playback device in the media playback system supports the audio format.

Example 25. The method of any one of the preceding Examples, wherein: the media playback system comprises at least one first playback device that supports the audio format; and the indication comprises an indication to use the at least one first playback device in the media playback system configuration.

Example 26. The method of any one of the preceding Examples, wherein: the media playback system comprises at least one second playback device that lacks capability to support the audio format; and the indication comprises an indication to exclude the additional playback device from the media playback system configuration.

Example 27. The method of any one of the preceding Examples, wherein: the media playback system comprises at least one synchrony group comprising: (i) at least one first playback device that supports the audio format, and (ii) at least one second playback device that lacks capability to support the audio format; and the indication comprises an indication to exclude the at least one second playback device from the synchrony group.

Example 28. A method comprising: receiving, via a user interface associated with a media playback system, a request to play back a first rendition of a media item via one or more playback devices of the media playback system, wherein the first rendition of the media item is available for playback by the one or more playback devices in a first audio format; determining that a second rendition of the media item is also available for playback by the one or more playback devices in a second audio format different than the first audio format; determining a capability of the at least one playback device to play back content in the second audio format; and based on the request and on the capability of the one or more media playback devices: cause the one or more playback devices to play back the first rendition of the media item in the first audio format; and provide, via the user interface, an indication that the second rendition is available for playback by the one or more playback devices.

Example 29. A method comprising: receiving an input indicating a search criteria for media content available for playback by a media playback system; based on the input, providing a list of media items available for playback by the media playback system that match the search criteria; receiving an indication of a particular audio format; determining a subset of media items in the list of media items available for playback in the particular audio format; and providing an indication of the subset of media items in the list of media items.

Example 30. The method of any one of the preceding Examples, wherein receiving the indication of a particular audio format comprises: receiving an indication of a particular playback device which is to play back the media content; and determining an audio format supported by the playback device, wherein the particular audio format is the audio format supported by the playback device.

Example 31. A method comprising: displaying a list of two or more groups of playback devices of a media playback system, wherein each group in the list of two or more groups comprises one or more playback devices; receiving an indication of a particular audio format; determining a subset of groups in the list of two or more groups capable of playing back content in the particular audio format, wherein the subset of groups includes at least one first group in the list of two or more groups and excludes at least one second group in the list of two or more groups; and displaying an indication of the subset of groups.

Example 32. A method comprising: displaying a list of two or more media services available to register with a media playback system; receiving an indication of a particular audio format; determining a subset of media services in the list of two or more groups capable of providing content in the particular audio format, wherein the subset of media services includes at least one first media service in the list of two or more media services and excludes at least one second media service in the list of two or more media services; and displaying an indication of the subset of media services.

Example 33. A method comprising: receiving, from a first media playback system, a first request to play back a media item, wherein the first request comprises a media item identifier; retrieving, using the media item identifier, the media item from a first data storage; causing the first media playback system to play back the media item; while the first media playback system is playing back the media item, determining an audio format of the media item; storing, in a second data storage different from the first data storage, an association of the audio format with the media item identifier; receiving, from a second media playback system different from the first media playback system, a request for media content in the audio format; determining that the media item is in the audio format based on the association stored in the second data storage; retrieving the media item from the first data storage using the media item identifier associated with the audio format in the second data storage; and causing the second media playback system to play back the media item.

Example 34. One or more tangible, non-transitory computer-readable media storing instructions that, when executed by one or more processors of a computing device or system, cause the computing device or system to perform operations comprising any one of the preceding Examples.

Example 35. A computing device comprising: one or more processors; and the one or more computer-readable media of Example 34.

1. A computing system comprising:
at least one processor;
at least one non-transitory computer-readable medium collectively comprising program instructions that are collectively executable via the at least one processor such that the computing system is configured to:
provide, via a user interface associated with a media playback system, a first indication that a media item is available in a first audio format;
receive, via the user interface, a request to play back, via one or more playback devices of the media playback system, the media item in the first audio format;
determine a current playback configuration of the one or more media playback devices, wherein the current playback configuration prevents playback of the first audio format;
based on the request and on the current playback configuration, provide, via the user interface, a second indication that the current playback configuration prevents playback of the first audio format; and
cause the one or more playback devices to play back a rendition of the media item, wherein the rendition of the media item is in a second audio format different from the first audio format.

2. The computing system of claim 1, wherein the first audio format comprises a spatial audio format and the second audio format comprises a non-spatial audio format.

3. The computing system of claim 1, wherein the user interface comprises one or more of a graphical user interface of any one or more of a controller or a playback device of the media playback system; a hardware user interface of any one or more of a controller or a playback device of the media playback system; or a voice user interface of any one or more of a controller or a playback device of the media playback system.

4. The computing system of claim 1, wherein the current playback configuration comprises one or more of:
a first playback device unable to support the first audio format;
a second playback device capable of supporting the first audio format, wherein the second playback device is in a synchrony group with the first playback device;
a communication channel or protocol unable to support the first audio format;
a streaming service unable to support the first audio format; or
a networking condition that prevents playback of the first audio format.

5. The computing system of claim 1, wherein the at least one non-transitory computer-readable medium further collectively comprises program instructions such that the computing system is configured to:
determine an alternative playback configuration that enables playback in the first audio format; and
provide, via the user interface, an indication of the alternative playback configuration.

6. The computing system of claim 5, wherein the at least one non-transitory computer-readable medium further collectively comprises program instructions such that the computing system is configured to:
detect a change from the current playback configuration to the alternative playback configuration; and
based on the change, cause the one or more playback devices to transition from playing back the rendition of the media item to playing back the media item in the first audio format.

7. The computing system of claim 5, wherein:
the current playback device configuration comprises at least one first playback device that lacks capability to play back content in the first audio format; and
the alternative playback configuration excludes the at least one first playback device.

8. The computing system of claim 5, wherein:
the current playback device configuration comprises at least one second playback device capable of playing back content in the first audio format; and
the alternative playback configuration includes the at least one second playback device.

9. A method comprising:
receiving, via a user interface associated with a media playback system, a request to play back a first rendition of a media item via one or more playback devices of the media playback system, wherein the first rendition of the media item is available for playback by the one or more playback devices in a first audio format;
determining that a second rendition of the media item is also available for playback by the one or more playback devices in a second audio format different than the first audio format;
determining a capability of the one or more playback devices to play back content in the second audio format; and
based on the request and on the capability of the one or more media playback devices:
cause the one or more playback devices to play back the first rendition of the media item in the first audio format; and
provide, via the user interface, an indication that the second rendition is available for playback by the one or more playback devices.

10. The method of claim 9, wherein the first audio format comprises a spatial audio format and the second audio format comprises a non-spatial audio format.

11. The method of claim 9, wherein the user interface comprises one or more of a graphical user interface of any one or more of a controller or a playback device of the media playback system; a hardware user interface of any one or more of a controller or a playback device of the media playback system; or a voice user interface of any one or more of a controller or a playback device of the media playback system.

12. The method of claim 9, wherein the current playback configuration comprises one or more of:
a first playback device unable to support the first audio format;
a second playback device capable of supporting the first audio format, wherein the second playback device is in a synchrony group with the first playback device;
a communication channel or protocol unable to support the first audio format;
a streaming service unable to support the first audio format; or
a networking condition that prevents playback of the first audio format.

13. The method of claim 9, further comprising:
determining an alternative playback configuration that enables playback in the first audio format; and
providing, via the user interface, an indication of the alternative playback configuration.

14. The method of claim 13, further comprising:
detecting a change from the current playback configuration to the alternative playback configuration; and
based on the change, causing the one or more playback devices to transition from playing back the second rendition of the media item to playing back the first rendition of the media item.

15. The method of claim 13, wherein:
the current playback device configuration comprises at least one first playback device that lacks capability to play back content in the first audio format; and
the alternative playback configuration excludes the at least one first playback device.

16. The method of claim 13, wherein:
the current playback device configuration comprises at least one second playback device capable of playing back content in the first audio format; and
the alternative playback configuration includes the at least one second playback device.

17. At least one tangible, non-transitory computer-readable medium collectively comprising program instructions that, when executed by one or more processors of a computing system, cause the computing system to:
provide, via a user interface associated with a media playback system, a first indication that a media item is available in a first audio format;
receive, via the user interface, a request to play back, via one or more playback devices of the media playback system, the media item in the first audio format;
determine a current playback configuration of the one or more media playback devices, wherein the current playback configuration prevents playback of the first audio format;
based on the request and on the current playback configuration, provide, via the user interface, a second indication that the current playback configuration prevents playback of the first audio format; and
cause the one or more playback devices to play back a rendition of the media item, wherein the rendition of the media item is in a second audio format different from the first audio format.

18. The at least one computer-readable medium of claim 17, wherein the first audio format comprises a spatial audio format and the second audio format comprises a non-spatial audio format.

19. The at least one computer-readable medium of claim 17, wherein the user interface comprises one or more of a graphical user interface of any one or more of a controller or a playback device of the media playback system; a hardware user interface of any one or more of a controller or a playback device of the media playback system; or a voice user interface of any one or more of a controller or a playback device of the media playback system.

20. The at least one computer-readable medium of claim 17, wherein the current playback configuration comprises one or more of:
a first playback device unable to support the first audio format;
a second playback device capable of supporting the first audio format, wherein the second playback device is in a synchrony group with the first playback device;
a communication channel or protocol unable to support the first audio format;
a streaming service unable to support the first audio format; or
a networking condition that prevents playback of the first audio format.
